(19) United States
(12) Patent Application Publication
(10) Pub. No.: US 2006/0200627 A1
(43) Pub. Date: Sep. 7, 2006

(54) Data archive system and method

(76) Inventor: Syed Iftikar, Pleasanton, CA (US)

Correspondence Address: PATRICK REILLY, P.O. BOX 7218, SANTA CRUZ, CA, 95061-7218, US

(21) Appl. No.: 11/351,878

(22) Filed: Feb. 10, 2006

Related U.S. Application Data
(63) Continuation-in-part of application No. 11/210,150, filed on Aug. 23, 2005.
(60) Provisional application No. 60/652,259, filed on Feb. 11, 2005.
(60) Provisional application No. 60/603,921, filed on Aug. 23, 2004.

(51) Int. Cl. G06F 12/14; G06F 12/00

(52) U.S. Cl. 711/114; 711/112; 711/161

(57) ABSTRACT

A data archive system and method are provided. A first version is a data archive connected to a high speed Ethernet link. The data archive includes a main central processing unit system coupled with both an Ethernet interface module and a communications switching circuit. A high speed communications bus communicatively couples the communications switching circuit with memory module managers. Each memory module manager includes a manager control module, a manager communications bus, and a plurality of paired memory module interfaces and solid state memory modules. The memory module interfaces are communicatively coupled with the manager communications bus and are each configured to enable (1.) communicative coupling of at least one solid state memory module, and (2.) hot swapping, coupling and decoupling of at least one solid state memory module. Certain alternate versions of the data archive include or present Redundant Array of Independent/Inexpensive Disk architecture, capabilities, elements, and/or circuits.

### RELATED APPLICATIONS

This patent application is a Continuation-in-Part patent application to U.S. Provisional Patent Application No. 60/652,259 entitled DATA ARCHIVE MEMORY SYSTEM AND METHOD as filed on Feb. 11, 2005 and claims the benefit of the priority date of that U.S. Provisional Patent Application No. 60/652,259. The aforementioned U.S. Provisional Patent Application No. 60/652,259 is hereby incorporated in its entirety and for all purposes in this patent application.

Furthermore, this patent application is also a Continuation-in-Part patent application to U.S. Nonprovisional patent application Ser. No. 11/210,150, entitled PORTABLE MEMORY SYSTEM AND DEVICE, filed on Aug. 23^{rd}, 2005, which is a Continuation Application of Provisional Patent Application No. 60/603,921 entitled PORTABLE MEMORY SYSTEM AND DEVICE, as filed on Aug. 23, 2004. This patent application therefore claims the benefit of the priority dates of the aforementioned U.S. Nonprovisional patent application Ser. No. 11/210,150 and the U.S. Provisional Patent Application No. 60/603,921. The aforementioned U.S. Nonprovisional patent application Ser. No. 11/210,150 and U.S. Provisional Patent Application No. 60/603,921 are hereby incorporated in their entirety and for all purposes in this patent application.

### FIELD OF THE INVENTION

The present invention relates to solid state memory devices, and in particular, to devices and systems that enable applications of digital data memory modules.

### BACKGROUND OF THE NVENTION

Digital memory archives presently comprise a large portion of the usage of solid state memory devices. Magnetic tape may currently provide 85% of the existing digital memory archive capacity of the world, while the remaining percentage of archive capacity is maintained on disc memory devices, eg., optical disks, compact discs (ferafter “CD”) and digital video discs (hereafter “DVD”).

Magnetic tape-based memory systems typically have slower access times but are less expensive to operate than prior art memory systems that primarily use disc memory devices or other solid state memory circuits, e.g, non-volatile Electrically Erasable Programmable Read Only Memory such as a FLASH memory.

The prior art therefore forces an undesirable choice in selecting digital memory archiving systems between (a.) lower priced, lower performance magnetic tape-based systems, and (b.) higher priced, higher performance sold state memory based systems.

Certain prior art solid state memory devices provide a controller that accesses memory location within a memory circuit, device or module controller, e.g., a FLASH memory or a disc memory

The term “FLASH memory” is used herein as is understood in the art to include a solid state, non-volatile, rewritable memory that functions like a combination of RAM and hard disk. FLASH memory is durable, operates at low voltages, and retains data when power is off.

A prior art digital memory disk drive system includes one or more memory bearing disks, such as optical disks or magnetic disks, each configured for storing digital data. Such disks are positioned within an enclosure and mounted on a rotational member of a motor. A data head is provided to read and/or write from and optionally to each disk. Means are provided for each data head to be controllably positioned relative to a corresponding disk in order to read from digital data or write digital data to a selected location of the disk. A data pathway enables data read from the disk to be communicated from and optionally to each data head and to an external device or system, such as a personal computer. An interface controller provides means for the external electronic device to operate the disk drive system. The financial expense of the control circuitry of many prior art solid state memory systems can contribute as much as, or more than, 20% of total monetary cost of a prior art solid state memory system.

It is therefore an object of the present invention to provide cost efficient solid state memory systems that present higher memory access performance than comparably priced magnetic tape-based digital memory systems.

### SUMMARY OF THE INVENTION

These and other objects are achieved by the method of the present invention that provides a hard disk drive device and system. A first preferred embodiment of the present invention comprises a data archive having an Ethernet interface circuit connected to a high speed Ethernet link. The data archive further includes a communications switching circuit coupled with both a main central processing unit system of the data archive and the Ethernet interface circuit. A high speed communications bus of the data archive communicatively couples the communications switching circuit with a plurality of memory module managers. Each memory module manager includes a manager control module, a manager communications bus, and a plurality of memory module interfaces and a plurality of solid state memory modules. The memory module interfaces are communicatively coupled with the manager communications bus and are each configured to enable (1.) communicative coupling of at least one solid state memory module, and (2.) hot swapping, coupling and decoupling of at least one solid state memory module. Certain alternate versions of the data archive include or present Redundant Array of Independent/Inexpensive Disk (hereafter “RAID”) architecture, capabilities, elements, and/or circuits.

### BRIEF DESCRIPTION OF THE DRAWINGS

The accompanying drawings, which are incorporated in and constitute a part of the specification, illustrates a preferred embodiment of the invention and, together with a general description given above and the detailed description of the preferred embodiment given below, serve to explain the principles of the invention.

FIG. 1 is a schematic diagram of a first preferred embodiment of the present invention comprising a data archive;

FIG. 2 is a schematic diagram of one memory module manager of the data archive of FIG. 1;

FIG. 3 is a schematic diagram of a representative data cartridge of the memory module manager of FIG. 2;

FIG. 4 is a schematic of a drive of a memory module interface of the memory module manager of FIG. 2;

FIG. 5 is a perspective view of an alternate data cartridge;

FIG. 6 illustrates the alternate data cartridge of FIG. 5 electromechanically coupled with an alternate memory module interface of the data archive of FIG. 1; and

FIG. 7 is a schematic drawing illustrating a plurality of host computers coupled with one or more module managers of the data archive of FIG. 1.

### DETAILED DESCRIPTION OF PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the present invention have been defined herein.

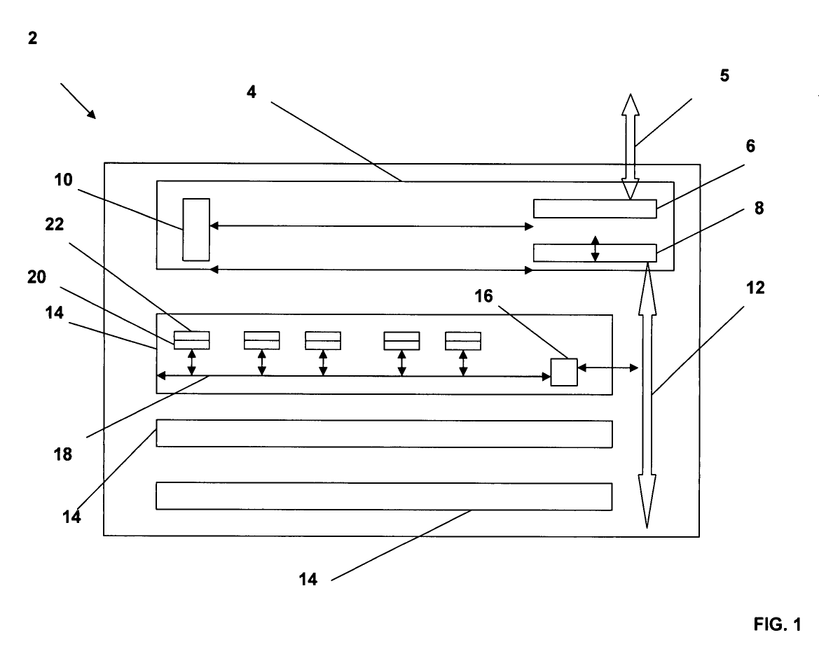

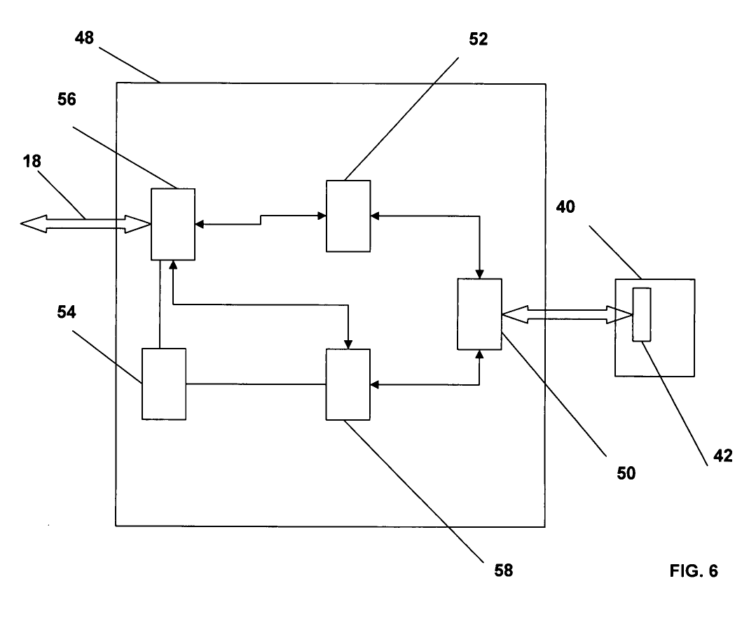

Referring now generally the Figures and particularly to FIG. 1, FIG. 1 is a schematic diagram of a first preferred embodiment of the present invention comprising a data archive 2, or first design 2. A control module 4 of the first design 2 is communicatively coupled to an external high speed Ethernet link 5 by means of an Ethernet interface circuit 6. The control module 4 is a control circuitry that further includes a communications switching circuit 8 coupled with both a main central processing unit system 10 of the control module 4 and the Ethernet interface circuit 6. A high speed communications bus 12 of the data archive 2 communicatively couples the communications switching circuit 8 with a plurality of memory module managers 14. Each memory module manager 14 includes a manager control module 16, a manager communications bus 18, and a plurality of memory module interfaces 20 and a plurality of solid state memory modules 22. One or more solid state memory modules may 22 comprise, in various alternate preferred embodiments of the Method of the Present Invention, may comprise a memory element selected from the group consisting of a electromagnetic disk, a CD, a DVD, an optical disk, an EEPROM memory, a FLASH memory, or other suitable solid state memory known in the art. In each memory module manager 14, the internal memory module interfaces 20 are communicatively coupled with the internal manager communications bus 18. The internal memory module interfaces 20 are each configured to enable (1.) communicative coupling of at least one solid state memory module 22, and (2.) hot swapping, coupling and decoupling of at least one solid state memory module 22 with the instant internal manager communications bus 18. As illustrated in FIG. 6, certain alternate versions of the data archive 2 include or present RAID architecture, capabilities, elements, and/or circuits.

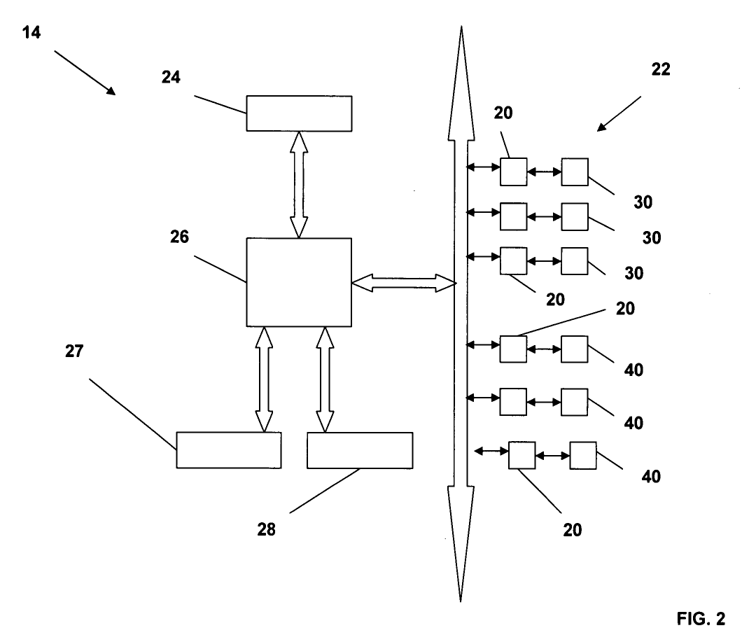

Referring now generally the Figures and particularly to FIG. 2, FIG. 2 is a schematic diagram of one memory module manager 14. The memory module manager includes a reduced instruction set computer processor 24 (hereafter “Risc processor 24”), a controller 26, SDRAM memory 27, FLASH memory 28, and a plurality of data cartridges 30. The data cartridges 30 are one alternate preferred embodiment of the plurality the solid state memory modules 22.

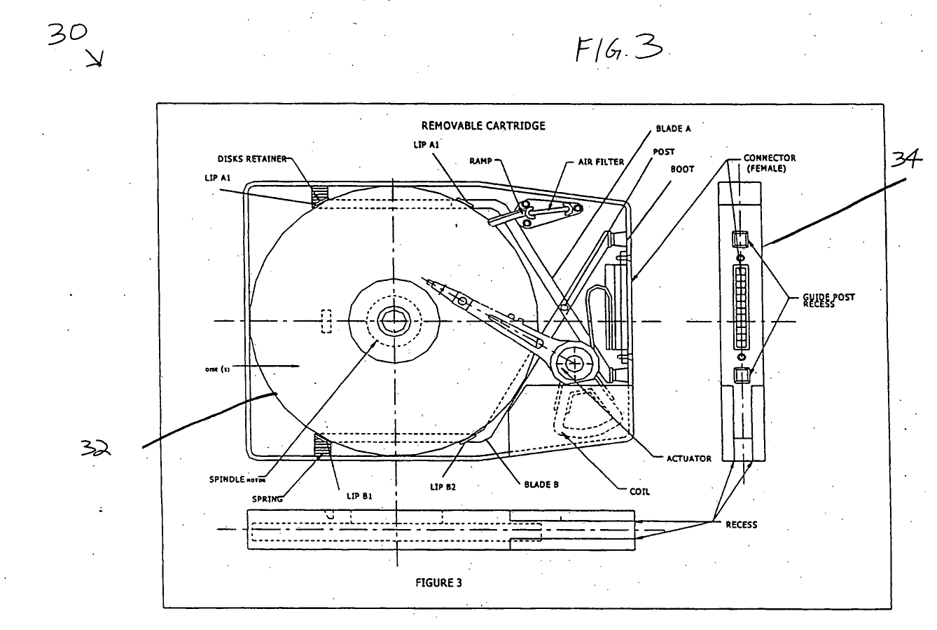

Referring now generally the Figures and particularly to FIG. 3, FIG. 3 is a schematic diagram of a representative data cartridge 30. The data cartridge 30 comprises a disc 32 configured for optically or magnetically storing digital data, e.g., a CD, a DVD, or other suitable magnetic or optical disk known in the art. A cartridge connector 34 is configured to enable removable coupling of the data cartridge 30 with a memory module interface 20 of a memory module manager 14.

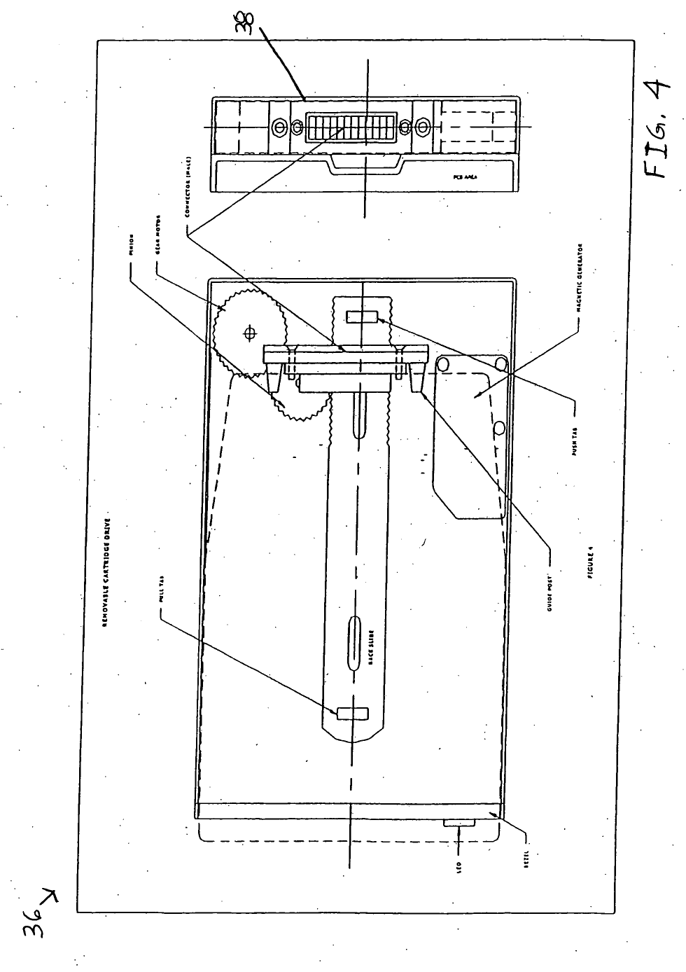

Referring now generally the Figures and particularly to FIG. 4, FIG. 4 is a schematic of a drive 36 of a memory module interface 20. A drive connector 38 is configured to electro-mechanically couple with the cartridge connector 34 of a data cartridge 30, and thereby enable bi-directional communicative coupling between the data cartridge 30 and the control module 4, wherein the control module, or control circuitry 4, directs the read and write operations of the cartridge 30 by sending and receiving electrical signals via the communications switching circuit 8, the high speed communications bus 12, a manager control module 16, a manager communications bus 18, and a drive 36 memory module interface 20, and a cartridge 30 that is electro-mechanically coupled with the drive connector 38. The cartridge connector 34 can be connected directly to the drive connector 38 attached directly to the control module manager 16 without the drive housing 36.

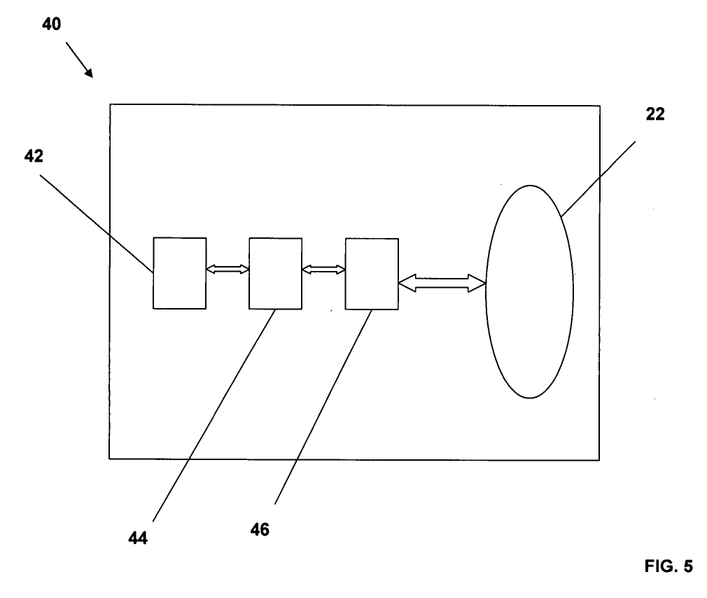

Referring now generally to the Figures and particularly to FIG. 5, FIG. 5 is a perspective view of an alternate data cartridge 40. A hot insertion connector 42 enables hot swapping of data cartridges 40, wherein a first alternate data cartridge 40 is decoupled from a memory module interface 20 of a manager communications bus 18 and a second data cartridge 40 is removably coupled with the same memory module interface 20, without interrupting the direction by the control module 4 of the other data cartridges 30 or alternate date cartridges 40 that are contemporaneously coupled with an internal manager communications bus 18. An electro-static discharge protection shelf bus interface 44 disposed between a head preamplifier 46 and the hot insertion connector 42 protects the alternate data cartridge 40 from damage caused by an electro-static discharge.

Referring now generally to the Figures and particularly to FIG. 6, FIG. 6 illustrates the alternate data cartridge 40 electromechanically coupled with an alternate memory module interface 48. The alternate memory module interface 48 is communicatively coupled with a manager communications bus 18. An interface hot insertion connector 50 of the alternate memory module interface 48 is configured to electro-mechanically couple with the hot insertion connector 42 and thereby communicatively couple the alternate data cartridge 40 with the control module 4. a power regulator 54 provides electrical power to a spindle motor driver 52, wherein the spindle motor driver 52 enables the disc 32 to rotate when the alternate cartridge 40 is coupled with the alternate memory module interface 48. A digital signal processor 56 receives electrical signals from, and sends electrical signals to, the control module 4. The digital signal processor 56 further communicates with a Partial Response Maximum Likelihood channel encoder 58. The Partial Response Maximum Likelihood (hereafter “PRML”) channel encoder 58 executes a method for converting the weak analog signal received from the head of the magnetic disk drive into a digital signal, wherein the digital signal is communicated from the PRML channel encoder 58 to the high speed communications bus 12 via the memory module manager 14. The PRML channel encoder 58 attempts to correctly interpret even small changes in the analog signal, whereas peak detection relies on fixed thresholds. Because PRML techniques can correctly decode a weaker signal it allows higher density recording on the disc 32 to be enabled for use in the data archive 2. The PRML channel encoder 58 is communicatively coupled with the digital signal processor 56 and the hot insertion connector 42. The digital signal processor controller 56, the PRML channel 58 and the power regulator 54 can be integrated into one integrated circuit.

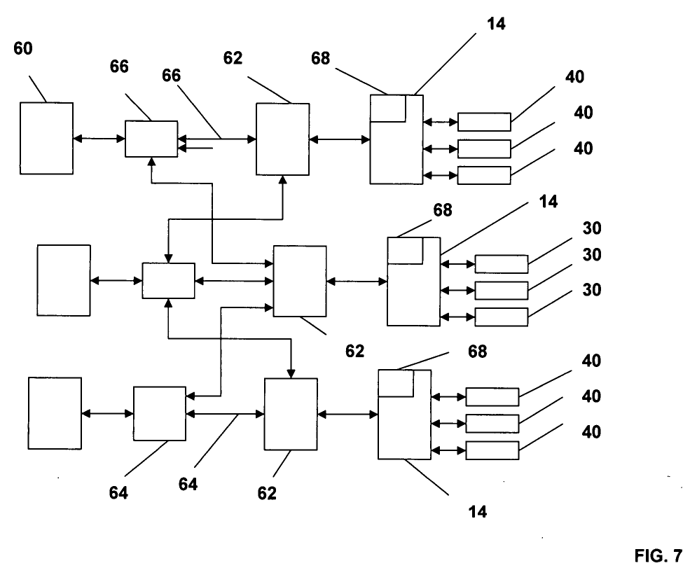

Referring now generally to the Figures and particularly to FIG. 7, FIG. 7 is a schematic drawing illustrating a plurality of host computers 60 are coupled with a plurality of SAN routers 62 by means of an Ethernet communications channel 64 and/or optical fiber signal pathways 66. Each SAN router 62 is communicatively coupled with a plurality memory module managers 14, wherein one or more module managers 14 includes a RAID module 66 and the RAID modules 66 are configured to provide RAID functionality to the instant memory module manager 14.

At any given moment one cartridge 30 or 40 can be selected for reading or writing by the control module manager 16 while the remaining cartridges 30 and 40 are in an auxiliary power mode or inactive mode. Each cartridge can be stopped, replaced and/or sequenced up to the auxiliary mode without affecting the operation of the remaining cartridges 30 and 40 that are contemporaneously coupled with the data archive 2.

Although the examples given include many specificities, they are intended as illustrative of only one possible embodiment of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

I claim:

1. A data storage system for digital data storage, the system comprising a control circuitry communicatively coupled with a plurality of solid state memory modules, each solid state memory module directed by the control circuitry in read and write operations, wherein only one solid state memory module is substantively performing a read or write operation at any one moment.

2. The system of claim 1, wherein a unique interface module is disposed between each solid state memory module and the control circuitry, and wherein each unique interface module communicatively removably couples the control circuitry with at least one solid state memory module.

3. The system of claim 2, wherein at least one interface module comprises a PRML device disposed between the solid state memory module and the control circuitry.

4. The system of claim 2, wherein at least one interface module is configured to enable disconnection of a first solid state memory module and subsequent connection with a second solid state memory module.

5. The system of claim 1, wherein at least one solid state memory module comprises a memory element selected form the group consisting of an electromagnetic disk, a CD, a DVD, an optical disk, an EEPROM memory, and a FLASH memory.

6. The system of claim 5, wherein the memory element is enclosed within a cartridge having an electrostatic discharge protection device disposed between the memory element and the control circuitry.

7. The system of claim 1, wherein the system further comprises a RAID module, the RAID module disposed between and communicatively coupled with the control circuitry and at least one solid state memory module.

8. The system of claim 1, wherein the control circuitry is communicatively coupled with an Ethernet.

9. An electronic digital data archive, the archive communicatively coupled with a bi-directional digital data channel, the archive comprising:
a. a control module, a plurality of data manager modules, communicatively coupled by a archive communications bus;
b. the control module comprising a bus switch circuit coupled with both a channel interface circuit and a CPU, the channel interface configured for coupling the bi-directional digital data channel with the CPU and the bus switch circuit, the CPU for directing the read and write operations of the plurality of data manager modules, and the switch circuit coupled with the archive communications bus and configured to enable the CPU to direct the read and write operations of the plurality of data manager modules by means of the archive communications bus; and
c. at least one plurality of data manager modules comprising a plurality of removably coupled solid state memory modules

10. The archive of claim 9, wherein at least one memory module manager includes a manager communications bus communicatively coupling a plurality of solid state memory modules with the archive communications bus.

11. The archive of claim 10, wherein a unique interface module is disposed between each solid state memory module and the manager communications bus, and each unique interface module communicatively couples the manager communications bus with at least one solid state memory module.

12. The archive of claim 11, wherein at least one interface module is configured to enable disconnection of a first solid state memory module and subsequent connection with a second solid state memory module.

13. The archive of claim 9, wherein at least one solid state memory module comprises a memory element selected form the group consisting of an electromagnetic disk, a CD, a DVD, an optical disk, an EEPROM memory, and a FLASH memory.

14. The system of claim 13, wherein at least one interface module comprises a PRML device disposed between the solid state memory module and the control circuitry.

15. The archive of claim 9, wherein the system further comprises a RAID module, the RAID module disposed between and communicatively coupled with the control circuitry and at least one solid state memory module.

16. The system of claim 9, wherein the control circuitry is communicatively coupled with an Ethernet.

17. A method for managing solid state memory, the method comprising:
a. providing a plurality of solid state memory devices coupled with a single control module; and
b. directing the read and write operations of the plurality of solid state memory devices by the single control module, wherein only one solid state memory is substantively performing a read or write operation at any one moment.

18. The method of claim 17, wherein each solid state memory device comprises a memory element selected form the group consisting of an electromagnetic disk, a CD, a DVD, an optical disk, an EEPROM memory, and a FLASH memory.

19. The method of claim 18, wherein the method further comprises providing a RAID module, the RAID module disposed between and communicatively coupled with the control module and at least one solid state memory module.

20. The method of claim 18, wherein the method further comprises providing an Ethernet communications channel to the control module.
